(19) United States
(12) Patent Application Publication
(10) Pub. No.: US 2004/0059954 A1
(43) Pub. Date: Mar. 25, 2004

(54) Automatic low power state entry

(76) Inventor: Rainer Hoehler, Durham, NC (US)

Correspondence Address: BRINKS HOFER GILSON & LIONE, ONE INDIANA SQUARE, SUITE 1600, INDIANAPOLIS, IN, 46204-2033, US

(21) Appl. No.: 10/252,153

(22) Filed: Sep. 20, 2002

(51) Int. Cl. G06F 1/26

(52) U.S. Cl. 713/300

(57) ABSTRACT

A low power mode system and method for a random access memory. A timer is provided for tracking a time period that has elapsed since a last memory access command was received by the random access memory. A comparator is connected to the timer for comparing said time period that has elapsed since a last memory access command was received by the random access memory with a predetermined threshold value. A state machine is connected to the comparator for placing said random access memory in a lower power mode when the time period exceeds the predetermined threshold value.

### FIELD OF THE INVENTION

The present invention relates generally to memory chips and more—particularly, to a dynamic random access memory (“DRAM”) having an onboard automatic low power mode system.

### BACKGROUND OF THE INVENTION

One of several challenges facing memory chip designers is to develop memory chips that minimize power consumption. As such, energy efficiency has become an important item for optimization in memory chips. Mobile devices need memory chips that are capable of extending battery life by not consuming as much power and desktop systems need to reduce power to meet noise or power consumption limitations. Memory chips are consuming an increasing amount of the allowable power allocation in computing devices and thus, efforts are being made to reduce power consumption and increase energy efficiency.

Memory chip manufacturers are attempting to meet this demand for energy efficient memory chips by manufacturing memory chips capable of operating in multiple power modes such as active, standby, power-down and deep-power-down. In order to process a memory request, the memory chip must be in active mode. Traditionally, the remaining modes are in the order of decreasing power consumption. As such, standby mode consumes more power than power-down mode and deep-power-down mode consumes the least amount of power. Each of these power modes also requires an increased amount of time to transition back to active mode. Therefore, it takes less time for a memory chip to return to active mode from standby mode than it does for a memory chip to return to active mode from power-down mode.

Placing memory chips in lower power states when they are not in use by the computing device system using the memory chip can increase energy efficiency. In prior art systems, the challenge for system designers has been to use these modes effectively to reduce power consumption. As such, external memory controllers must be programmed to set the memory chips in low power modes when not in use. This requires designers to spend a considerable amount of time and effort developing code and designs that are capable of accurately knowing when to place the memory chips into the various low power modes.

As such, a need exists for a memory chip that is capable of placing itself into a low power mode without the assistance of an external memory controller.

### SUMMARY OF THE INVENTION

A preferred embodiment of the present invention discloses a low power mode system for a random access memory. The low power mode system includes a command decoder for detecting a memory access command. A timer is connected to the command decoder. The timer is operable to track an amount of time that has elapsed since the command decoder has received the memory access command. A comparator is connected to the timer. A threshold register is connected to the comparator, wherein the comparator is operable to compare a predetermined threshold value in the threshold register with the amount of time that has elapsed since the command decoder has received the memory access command. A state machine is connected to the comparator for entering a new power mode if the amount of time that has elapsed since the command decoder has received the memory access command exceeds the predetermined threshold value.

Another preferred embodiment discloses a method of placing a random access memory in a low power mode. A command decoder is used to detect a memory access command. A time period that has elapsed since receiving the memory access command is tracked with a timer that is connected to the command decoder. A comparator is used to compare the time period that has elapsed since receiving the memory access command with a predetermined threshold value. If the time period that has elapsed since receiving the memory access command exceeds the predetermined threshold value the random access memory is placed in a lower power mode.

The memory access commands may be selected from a group of memory access commands consisting of a read command or a write command. The timer may be a refresh timer of the random access memory or a timer especially designed for the low power mode system. The predetermined threshold value may be programmed in the random access memory using an external memory controller or programmed during manufacture. The predetermined threshold value is preferentially stored in a register. The lower power mode may be selected from a group of lower power modes consisting of a standby mode, a power-down mode and a deep-power-down mode.

Further objects and advantages of the present invention will be apparent from the following description, reference being made to the accompanying drawings wherein preferred embodiments of the invention are clearly illustrated.

### BRIEF DESCRIPTION OF THE DRAWINGS

FIG. 1 illustrates a preferred low power mode system for a random access memory.

FIG. 2 is a flow chart illustrating the preferred process steps taken by the random access memory when entering various low power modes.

### DETAILED DESCRIPTION OF THE PRESENTLY PREFERRED EMBODIMENTS OF THE INVENTION

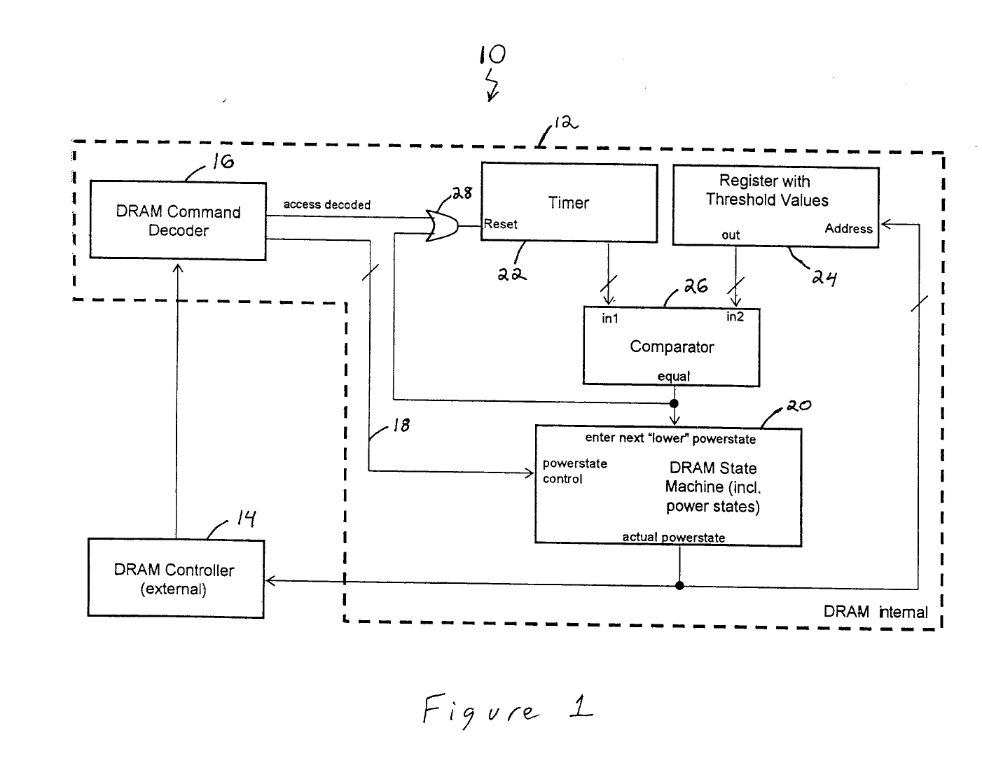

Referring to FIG. 1, a preferred embodiment of the present invention discloses a low power mode system 10 for a random access memory (“RAM”) 12. The preferred RAM 12 is illustrated as a dynamic random access memory (“DRAM”) in FIG. 1. However, those skilled in the art of memory chips should recognize that the presently disclosed low power mode system 10 could also be incorporated into other RAM chips such as static random access memory (“SRAM”).

As illustrated in FIG. 1, an external memory controller 14 is connected to the RAM 12. As known in the art, during normal operation the external memory controller 14 is used to read and write data to and from the RAM 12. The external memory controller 14 is connected to a command decoder 16 of the RAM 12. The command decoder 16 is used to control operation of the RAM 12 so that, amongst other things, data can be written to and retrieved from the RAM 12. During normal operation, the external memory controller 14 is used to issue commands to the RAM 12 that allows external systems to read and write data to and from the RAM 12. As set forth above, in prior art memory designs the external memory controller 14 is capable of setting the RAM 12 into various power modes, which include active, standby, power-down and deep-power-down mode.

In the preferred embodiment illustrated in FIG. 1, the command decoder 16 is capable of receiving commands or instructions from the external memory controller 14 that will cause the command decoder 16 to place the RAM 12 into one of the above-referenced power modes. As illustrated, a power mode control bus 18 is connected to a state machine 20 that allows the command decoder 16 to place the RAM 12 into one of the respective power modes. The external command controller 14 is therefore capable of forcing the RAM 12 into active, standby, power-down or deep-power-down mode.

The preferred low power mode system 10 of the RAM 12 includes a timer 22 that is connected to the command decoder 16. The timer 22 of the RAM 12 is used to measure and keep track of the amount of time that has elapsed since the RAM 12 has been accessed by the external memory controller 14. As such, the timer 22 functions as a means for keeping track of the amount of time that has passed between respective memory accesses. In the preferred embodiment of the present invention, the timer 22 is reset with each memory access. As such, each time the external memory controller 14 issues an instruction to the RAM 12, which corresponds to a read or write access of the RAM 12, the timer 22 is reset to an initial value.

An output bus of the preferred timer 22 is connected to a first input of a comparator 26. As further illustrated in FIG. 1, a register 24 containing threshold values is connected to the comparator 26. In the preferred embodiment of the present invention, the output bus of the register 24 is connected to a second input of the comparator 26. The threshold values are preferentially predetermined values that are programmed by the external memory controller 14 or set during manufacture. In the preferred embodiment of the present invention, the predetermined values are programmed into an extended memory register of the RAM 12.

The comparator 26 is operable to compare the timer value with the predetermined threshold value that is stored in the register 24. Whenever a threshold value has been reached, the RAM 12 enters a lower power mode or changes from one low power mode to the next low power mode with even less power consumption. For example, the RAM 12 can be programmed to go directly from active mode to power-down mode or may go from standby mode to power-down mode. This functionality provides the RAM 12 with a means for transitioning from one power mode to a lower power mode based on the amount of time that has elapsed since the RAM 12 was accessed by the external memory controller 14. As such, the present invention does not require the external memory controller 14 to set the RAM 12 into one of the lower power modes.

Referring to FIG. 1, if a read or write access is made to the command decoder 16 of the RAM 12, the timer 22 is reset by a signal received from an OR logic gate 28 that is connected to the command decoder 16 and the output of the comparator 26. The use of an OR logic gate 28 should not be construed as a limitation of the present invention unless otherwise specifically claimed. An output of the command decoder 16 and the comparator 26 are connected to the inputs of the OR logic gate 28. During operation, the timer 22 can be reset by the command decoder 16 receiving a read or write access command or by the output of the comparator 26.

The output of the comparator 26 is used to reset the timer 22 and to inform the state machine 20 of the need to change power modes. As illustrated, the output of the comparator 26 is connected to the state machine 20. Once the timer 22 has reached the threshold value, the output from the comparator 26 preferentially instructs the state machine 20 to place the RAM 12 into the next “lower” power mode. In the preferred embodiment, the state machine 20 is also connected to the register 24. An extended memory register is preferentially set to a predefined value when the RAM 12 enters a different power mode thereby allowing the external memory controller 14 to know the current power mode of the RAM 12. The external memory controller 14 preferentially does this by decoding the address of register 24 that stores this information as illustrated in FIG. 1.

Although not illustrated, to use existing resources within the RAM 12 the timer 22 could be the refresh timer. The refresh timer of the RAM 12is usually running in all power modes. If the refresh timer is used, the difference of the actual value minus the value of the last memory access can be used to determine if the threshold value has been reached. As such, in this embodiment the comparator 26 would include a subtraction logic circuit that is used to determine if the threshold value has been met. The threshold values can be preset in the RAM 12 or several sets of thresholds can be preset in the RAM 12 and stored in an extended mode register.

In an alternative embodiment, the threshold values can be determined by monitoring predetermined bit-patterns of existing timers within the RAM 12. The comparator 26 is used to check a subset of the timer bits. In the preferred embodiment, whenever this pattern occurs two times without a memory access between, the RAM 12 enters the next lower power mode. The threshold values will vary depending on the selected bits of the timer 22. The threshold values can be stored in the extended mode register and different sets of bits can be selected for monitoring.

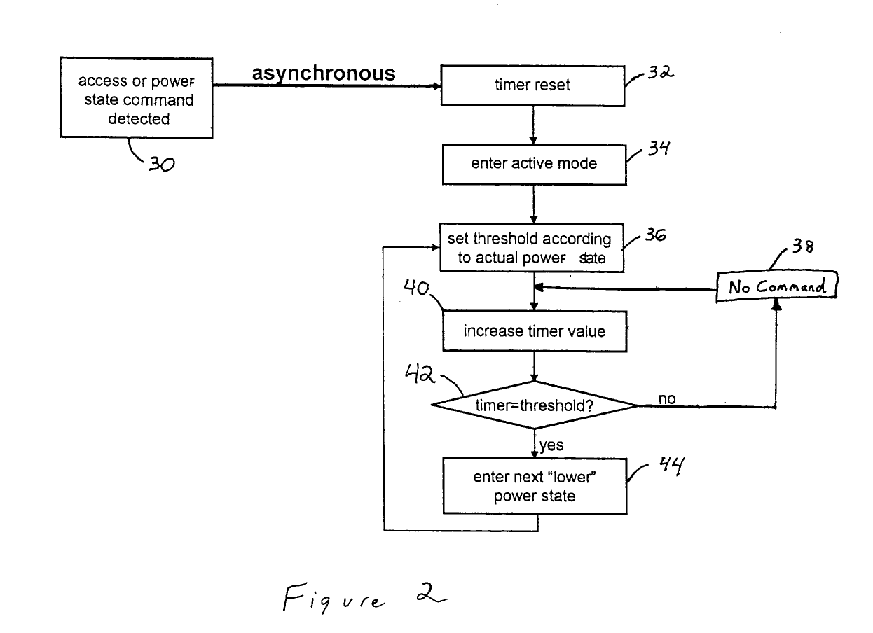

Referring to FIG. 2, the preferred method steps performed by the low power mode system 10 of the RAM 12 are illustrated. At step 30, the command decoder 16 detects a memory access command or a power state mode command. In response, at step 32 the timer 22 is reset by the command decoder 16. In the case of a memory access, the RAM 12 will enter an active mode, which is represented at step 34. At step 36, the RAM 12 ensures that the threshold value has been set for the appropriate power mode. For example, different threshold values can be stored for different power modes.

Step 38 represents what occurs if the RAM 12 is not accessed or does not receive a power state command from the external memory controller 14. If no access commands (which could include read or write commands) or power state commands are received by the command decoder 16, at step 38 the timer 22 increases its value. The comparator 26 then compares the value of the timer 22 to the threshold value and determines if the value of the timer 22 equals the threshold value, which is represented at step 42. If the timer value and the threshold value are equal, the comparator 26 instructs the state machine 20 to cause the RAM 12 to enter the next “lower” power mode as illustrated at step 44. If the timer value and the threshold value are not equal, the RAM 12 returns to step 38.

While the invention has been described in its currently best-known modes of operation and embodiments, other modes, embodiments and advantages of the present invention will be apparent to those skilled in the art and are contemplated herein. Although those skilled in the art would recognize that other embodiments of the present invention are envisioned, it is the claims that follow that that define the broad scope of the present invention.

What is claimed is:

1. A low power mode system for a random access memory, comprising:
a command decoder for detecting a memory access command;
a timer connected to said command decoder, wherein said timer is operable to track an amount of time that has elapsed since said command decoder has received said memory access command;
a comparator connected to said timer;
a threshold register connected to said comparator, wherein said comparator is operable to compare a predetermined threshold value in said threshold register with said amount of time that has elapsed since said command decoder has received said memory access command; and
a state machine connected to said comparator for entering a new power mode if said amount of time that has elapsed since said command decoder has received said memory access command exceeds said predetermined threshold value.

2. The low power mode system of claim 1, further comprising an external memory controller connected to said command decoder.

3. The low power mode system of claim 1, wherein said timer is a refresh timer of said random access memory.

4. The low power mode system of claim 1, wherein said new power mode may be selected from a group of power modes consisting of standby, power-down and deep-power-down.

5. The low power mode system of claim 1, wherein said predetermined threshold value is programmed using an external memory controller.

6. The low power mode system of claim 1, wherein said predetermined threshold value is pre-programmed during manufacture.

7. The low power mode system of claim 1, wherein said timer is an existing timer in said random access memory, wherein said timer monitors bit patterns of said existing timer.

8. A method of placing a random access memory in a low power mode, comprising the steps of:
monitoring a command decoder for a memory access command;
tracking a time period that has elapsed since receiving said memory access command with a timer;
comparing said time period that has elapsed since receiving said memory access command with a predetermined threshold value; and
placing said random access memory in a lower power mode if said time period that has elapsed since receiving said memory access command exceeds said predetermined threshold value.

9. The method of claim 8, wherein said memory access command may be selected from a group of memory access commands consisting of a read command or a write command.

10. The method of claim 8, wherein said timer comprises a refresh timer of said random access memory.

11. The method of claim 8, wherein said predetermined threshold value is programmed in said random access memory using an external memory controller.

12. The method of claim 8, wherein said predetermined threshold value is programmed during manufacture.

13. The method of claim 8, wherein said predetermined threshold value is stored in a register.

14. The method of claim 8, wherein a comparator compares said time period that has elapsed since receiving said memory access command with a predetermined threshold value.

15. The method of claim 8, wherein a state machine places said random access memory in a lower power mode.

16. The method of claim 8, wherein said lower power mode may be selected from a group of lower power modes consisting of a standby mode, a power-down mode and a deep-power-down mode.

17. The method of claim 8, further comprising the step of notifying an external memory controller of said lower power mode.

18. The method of claim 17, wherein a register is set in said random access memory to indicate said lower power mode.

19. The method of claim 8, wherein said timer is an existing timer in said random access memory and a comparator monitors a predetermined bit-pattern of said existing timer to track said time period that has elapsed since receiving said memory access command.

20. A low power mode system for a random access memory, comprising:
a timer for tracking a time period that has elapsed since a last memory access command was received by said random access memory;
a comparator connected to said timer for comparing said time period that has elapsed since a last memory access command was received by said random access memory with a predetermined threshold value; and
a state machine connected to said comparator for placing said random access memory in a lower power mode when said time period exceeds said predetermined threshold value.

21. The low power mode system of claim 20, wherein said timer is connected to a command decoder for tracking said time period that has elapsed since a last memory access command was received by said random access memory.

22. The low power mode system of claim 21, further comprising an external memory controller connected to said command decoder.

23. The low power mode system of claim 20, wherein a register is connected to said comparator and said register stores said predetermined threshold value.

24. The low power mode system of claim 23, wherein an external memory controller is operable to program said predetermined threshold value.

25. The low power mode system of claim 23, wherein said register is programmed with said predetermined threshold value during manufacture.
